(19) United States
(12) Patent Application Publication
(10) Pub. No.: US 2023/0234250 A1
(43) Pub. Date: Jul. 27, 2023

(54) EASY-TO-OPERATE ELECTRIC SCISSORS

(71) Applicant: SHENZHEN RUITIAN TECHNOLOGY CO., LTD, SHENZHEN (CN)

(72) Inventor: LIQIN LIN, PUTIAN (CN)

(21) Appl. No.: 17/585,577

(22) Filed: Jan. 27, 2022

(51) Int. Cl. B26B 15/00

(52) U.S. Cl. CPC B26B 15/00

(57) ABSTRACT

The present application relates to the technical field of electric scissors, and more specifically to a pair of easy-to-operate electric scissors. The electric scissors comprise a base, wherein the base is fixedly connected to a first blade, the base is rotationally connected to a number of second blades, the second blade is located directly above the first blade, an end of the first blade away from the base is provided with a trapezoidal cut, a movable end of the second blade is arranged in a V shape, and the base is provided with a drive structure for driving the second blade to rotate back and forth within a range of the trapezoidal cut. The present application has the advantages of a small size, light weight, a simple structure, convenient fine cutting, easy operation, etc.

### TECHNICAL FIELD

The present application relates to the technical field of electric scissors, and more specifically to a pair of easy-to-operate electric scissors.

### BACKGROUND ART

Existing electric cutting tools are applied to many fields, such as hair cutting services, gardening and agriculture.

Electric scissors are a handheld electric tool that is powered by a motor and drives a working head through a transmission mechanism to perform a shear operation.

At present, existing electric scissors are complex in structure; and when used, because they are large in size and inconvenient to carry, and most of the existing electric scissors are supported by manual handrails in determining a cutting direction, existing electric cutting operations are difficult, and it is extremely difficult for a beginner to control.

### SUMMARY OF THE INVENTION

In view of the above disadvantages of the prior art, an objective of the present application is to provide a pair of easy-to-operate electric scissors, which have the advantages of a small size, light weight, a simple structure, convenient fine cutting, easy operation, etc.

The above technical objective of the present application is achieved by the following technical solutions: a pair of easy-to-operate electric scissors comprising a base, wherein the base is fixedly connected to a first blade, the base is rotationally connected to a number of second blades, the second blade is located directly above the first blade, an end of the first blade away from the base is provided with a trapezoidal cut, a movable end of the second blade is arranged in a V shape, and the base is provided with a drive structure for driving the second blade to rotate back and forth within a range of the trapezoidal cut.

Preferably, a handle portion extends from the base.

Preferably, the drive structure comprises a drive member provided in an inner cavity of the handle portion and an eccentric gear mechanism fixedly connected to a connecting end of the drive member, and the eccentric gear mechanism is connected to the first blade.

Preferably, an end of the handle portion away from the base is provided with a control module electrically connected to the drive member.

Preferably, the control module comprises a circuit board electrically connected to the drive member, an input end of the circuit board is connected to a resettable fuse, and the handle portion is provided with a control button for controlling the circuit board.

Preferably, an end of the base away from the first blade is provided with a connection port electrically connected to the drive structure.

In conclusion, the beneficial effects of the present application are as follows: the base is moved to a place where cutting is required, thereby determining a cutting area through the trapezoidal cut provided at the end of the first blade away from the base, and making the first blade directly face a cutting part; the drive structure drives the second blade to rotate back and forth; and because the second blade is located directly above the first blade, it is convenient to perform cutting within the trapezoidal cut. Therefore, the present application has the advantages of a small size, light weight, a simple structure, convenient fine cutting, easy operation, etc.

### BRIEF DESCRIPTION OF THE DRAWINGS

FIG. 1 is a schematic structural view of an embodiment of the present application;

FIG. 2 is an exploded view of an embodiment of the present application; and

FIG. 3 is a schematic view of a circuit connection in an embodiment of the present application.

Reference signs: 1. Base; 11. First blade; 12. Second blade; 13. Trapezoidal cut; 2. Handle portion; 3. Drive member; 31. Eccentric gear mechanism; 4. Circuit board; 41. Resettable fuse; 42. Control button; 5. Connection port; 51. Power adapter; 52. Extension cord.

### DETAILED DESCRIPTION OF EMBODIMENTS

In order to make the technical problems to be solved by the present application, the technical solutions and the beneficial effects clearer, the present application is described in further detail below with reference to the accompanying drawings and embodiments. It should be understood that the specific embodiments described herein are merely used for explaining the present application, but not for limiting the present application.

It should be noted that when a component is referred to as being “fixed to” or “arranged at” a further component, it can be directly on the further component or indirectly on the further component. When a component is referred to as being “connected to” a further component, it can be directly or indirectly connected to the further component.

It should be understood that the orientation or position relationships indicated by terms “length”, “width”, “upper”, “lower”, “front”, “rear”, “left”, “right”, “vertical”, “horizontal”, “top”, “bottom”, “inner”, “outer”, etc. are based on the orientation or position relationships shown in the accompanying drawings and are only for facilitating the description of the present application and simplifying the description, rather than indicating or implying that the device or element referred to must have a particular orientation or be constructed and operated in a particular orientation, and therefore should not be interpreted. as limiting the present application.

In addition, terms “first” and “second” are merely used for descriptive purposes, and should not be constructed as indicating or implying relative importance or implicitly indicating the number of technical features indicated. Thus, features defined with “first” and “second” can explicitly or implicitly comprise one or more of the features. In the description of the present application, the meaning of “a plurality of” is two or more, unless otherwise explicitly and specifically defined.

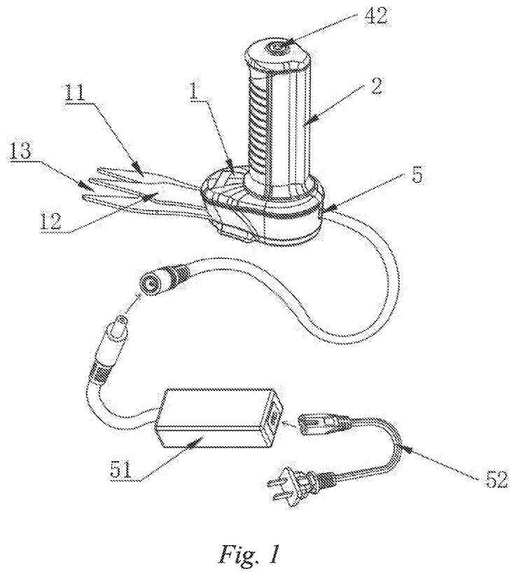

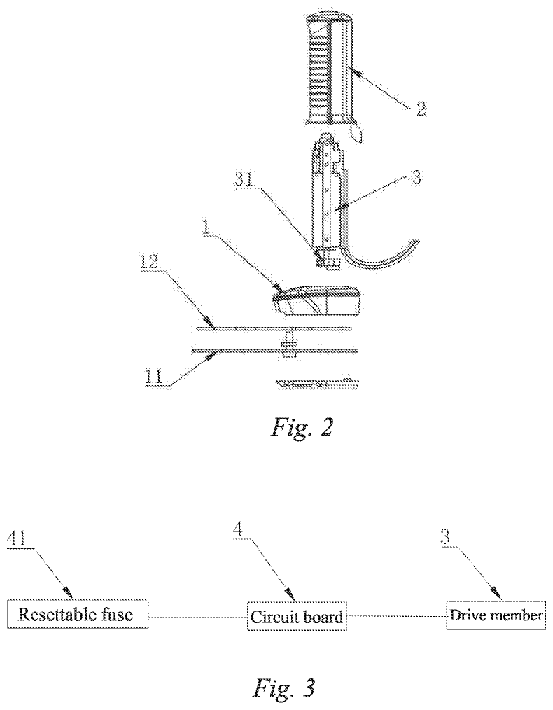

Referring to FIGS. 1 to 3, a pair of easy-to-operate electric scissors comprise a base 1. The base 1 is fixedly connected to a first blade 11, the base 1 is rotationally connected to a number of second blades 12, the second blade 12 is located directly above the first blade 11, an end of the first blade 11 away from the base 1 is provided with a trapezoidal cut 13, a movable end of the second blade 12 is arranged in a V shape, and a drive structure for driving the second blade 12 to rotate back and forth within a range of the trapezoidal cut 13 is provided in the base 1.

In this embodiment, the base 1 is moved to a place where cutting is required, thereby determining a cutting area through the trapezoidal cut 13 provided at the end of the first blade 11 away from the base 1, and making the first blade 11 directly face a cutting part; the drive structure drives the second blade 12 to rotate back and forth; and because the second blade 12 is located directly above the first blade 11, it is convenient to perform cutting within the trapezoidal cut 13. Therefore, the present application has the advantages of a small size, light weight, a simple structure, convenient fine cutting, easy operation, etc.

Specifically, a handle portion 2 extends from the base 1.

The arrangement of the handle portion 2 facilitates handle grabbing and controlling, thereby facilitating cutting.

Specifically, the drive structure comprises a drive member 3 provided in an inner cavity of the handle portion 2 and an eccentric gear mechanism 31 fixedly connected to a connecting end of the drive member 3, and the eccentric gear mechanism 31 is connected to the first blade 11.

The drive member 3 in this embodiment is a motor, and the eccentric gear mechanism 31 is driven by the motor, so that the first blade 11 connected to the eccentric gear mechanism 31 rotates back and forth, thereby implementing cutting by the first blade 11.

Specifically, an end of the handle portion 2 away from the base 1 is provided with a control module electrically connected to the drive member 3.

The control module controls the driving of the drive member 3, thereby controlling the driving of the first blade 11, which facilitates operation.

Specifically, the control module comprises a circuit board 4 electrically connected to the drive member 3, an input end of the circuit board 4 is connected to a resettable fuse 41, and the handle portion 2 is provided with a control button 42 for controlling the circuit board 4.

The input end of the circuit board 4 is connected to the resettable fuse 41. The resettable fuse 41 is automatically disconnected when a current is excessive, thereby effectively avoiding an excessive current caused when the motor is stuck in a clipping process, avoiding the generation of high heat, and preventing a circuit from being burned out, which improves safety.

In addition, the control button 42 is provided at the end of the handle portion 2, which prevents accidental touch and facilitates control.

Specifically, an end of the base 1 away from the first blade 11 is provided with a connection port 5 electrically connected to the drive member 3.

The connection port 5 and the first blade are arranged opposite to each other, which facilitates control and effectively prevents a power cord from interfering with operation.

The connection port 5 is connected to a power adapter 51, so that the electric cutting tool with an automatic power-off function can be connected to the mains, in order to increase the wiring length, an extension cord 52 is provided between the power adapter 51 and a power socket.

The above embodiment is merely an explanation of the present application, and is not a limitation to the present application. After reading this specification, those skilled in the art can make modifications to the embodiment without creative contributions as needed, but the modifications are protected by the patent law as long as they fall within the scope of the claims of the present application.

1. A pair of electric scissors, comprising a base, wherein the base is fixedly connected to a first blade, the base is rotationally connected to a second blade, the second blade is located directly above the first blade, an end of the first blade away from the base is provided with a trapezoidal cut, a movable end of the second blade is arranged in a V shape, and the base is provided with a drive structure for driving the second blade to rotate back and forth within a range of the trapezoidal cut, wherein the range is defined by unparallel opposite sides of the trapezoidal cut;
wherein a handle portion extends from the base to be grabbed by a user; the drive structure comprises a drive member provided in an inner cavity of the handle portion and an eccentric gear mechanism fixedly connected to a connecting end of the drive member, and the eccentric gear mechanism is connected to the first blade.

2-3. (canceled)

4. The pair of electric scissors according to claim 3, wherein an end of the handle portion away from the base is provided with a control module electrically connected to the drive member.

5. The pair of electric scissors according to claim 4, wherein the control module comprises a circuit board electrically connected to the drive member, an input end of the circuit board is connected to a resettable fuse, and the handle portion is provided with a control button for controlling the circuit board.

6. The pair of electric scissors according to claim 1, wherein an end of the base away from the first blade is provided with a connection port electrically connected to the drive structure.
